(19) United States
(12) Patent Application Publication
(10) Pub. No.: US 2016/0319526 A1
(43) Pub. Date: Nov. 3, 2016

(54) FAUCET WATER FILTERING DEVICE

(71) Applicant: Xiamen Runner Industrial Corporation, Xiamen (CN)

(72) Inventors: Tianming Xie, Xiamen (CN); Yunchuan Wang, Xiamen (CN); Desheng Liang, Xiamen (CN)

(21) Appl. No.: 15/138,803

(22) Filed: Apr. 26, 2016

(30) Foreign Application Priority Data
Apr. 29, 2015 (CN) 201520267889.X

(51) Int. Cl. E03C 1/04; C02F 1/00; F16K 11/085

(52) U.S. Cl. CPC E03C 1/0405; F16K 11/085; C02F 1/003; E03C 2201/40; C02F 2201/005; C02F 2209/40; C02F 2301/043; C02F 2307/06

(57) ABSTRACT

A faucet water filtering device includes a shell, provided with a water input port on its top portion; a valve seat, disposed in the shell, and provided with a working valve having one input and three outputs; a ceramic valve core component, disposed in the valve seat; a flow meter connection rod, inserted into a side of the shell; a filter core, disposed on a side of the shell; a filter core connection seat, disposed on a side of the shell for receiving the filter core, and connected to first water output port of the valve seat through the flow meter connection rod by means of a water route; and a connection seat, disposed on bottom of the valve seat, and provided with raw water and shower water hole channels corresponding to water output ports at bottom of the shell.

### BACKGROUND OF THE INVENTION

1. Field of the Invention

The present invention relates to a filtering device, and in particular to a faucet water filtering device used in an ordinary household.

2. The Prior Arts

Usually, in ordinary households, users tend to have different demands for the types of water output. Some users desire to use pure water, other users may prefer to use raw water, while some other users require to use shower water. However, the faucet presently on the market is not able to meet all these demands at the same time. Also, the output amount of faucet water can not be controlled precisely.

Therefore, presently, the design and performance of faucet water filtering device is not quite satisfactory, and it leaves much room for improvement.

### SUMMARY OF THE INVENTION

In view of the problems and drawbacks of the prior art, the present invention provides a faucet water filtering device, to effectively overcome the shortcomings of the prior art.

A major objective of the present invention is to provide a faucet water filtering device, including: a shell, a valve seat, a ceramic valve core component, a flow meter connection rod, a filter core, a filter core connection seat, and a connection seat. Wherein, the shell is provided with a water input port on its top portion. The valve seat is disposed in the shell, and is provided with a working valve having one input and three outputs, while an upper end of the valve seat is connected to the water input port. The ceramic valve core component is disposed in the valve seat. The flow meter connection rod is inserted into a side of the shell, while the filter core is disposed on a side of the shell. The filter core connection seat is disposed on a side of the shell for receiving the filter core, and is connected to a first water output port of the valve seat through the flow meter connection rod by means of a water route. And the connection seat is disposed on bottom of the valve seat, and is provided with raw water and shower water hole channels corresponding to water output ports at bottom of the shell, and is connected to a second water output port and a third water output port of the valve seat by means of the water routes.

In an aspect of the present invention, the faucet water filtering device further comprises: a water input connector, a water input filter plate, and an input water faucet screw tight nut, on a water input port of the valve seat.

In another aspect of the present invention, at bottom of the filter core connection seat is provided with a raw water output port connected and in communication with a filter core water output port.

In a further aspect of the present invention, the ceramic valve core component includes following elements disposed in sequence: a valve core support rack, a fix ceramic plate, a movable ceramic plate, a valve core rotation axis, a friction plate, and a valve core outer shell.

In a yet another aspect of the present invention, the faucet water filtering device further comprises a valve core tight seal pad, disposed each on both sides of the valve core support rack.

In another aspect of the present invention, the faucet water filtering device further comprises a tight seal pad disposed between the connection seat and the valve seat.

The advantage of the present invention is that, it is simple in construction, facile to operate, and is able to meet the demands of various users, such that it has a good prospect in the market.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

The related drawings in connection with the detailed descriptions of the present invention to be made later are described briefly as follows, in which:

FIG. 1 is a perspective view of a faucet water filtering device according to an embodiment of the present invention;

FIG. 2 is an exploded view of a faucet water filtering device as shown in FIG. 1 according to an embodiment of the present invention;

FIG. 3 is a cross section view of a faucet water filtering device while outputting pure water according to an embodiment of the present invention;

FIG. 4 is a cross section view of a faucet water filtering device while outputting raw water according to an embodiment of the present invention;

FIG. 5 is a cross section view of a faucet water filtering device while outputting shower water according to an embodiment of the present invention;

FIG. 6 is an exploded view of a ceramic valve core component according to an embodiment of the present invention; and

FIG. 7 is a schematic diagram of water route in a ceramic valve core component according to an embodiment of the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

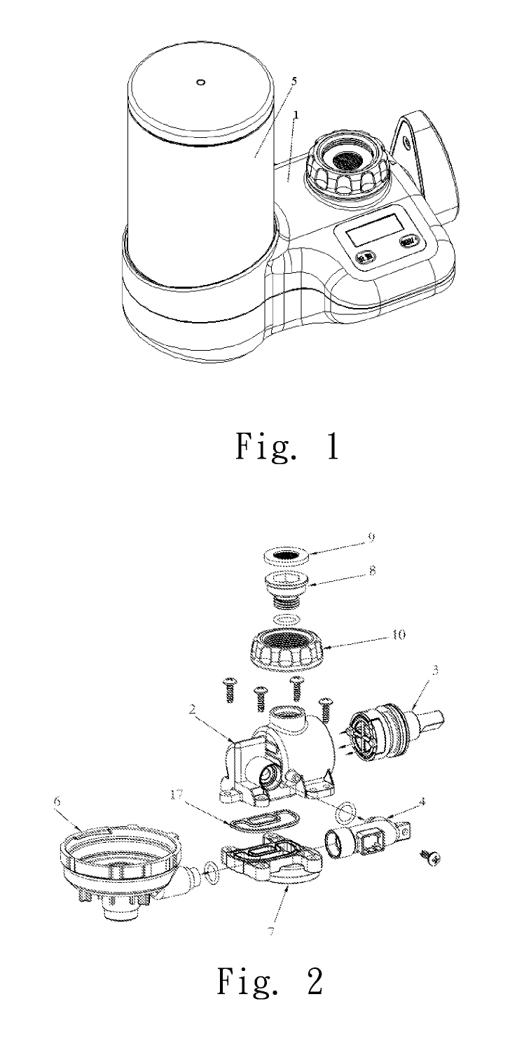

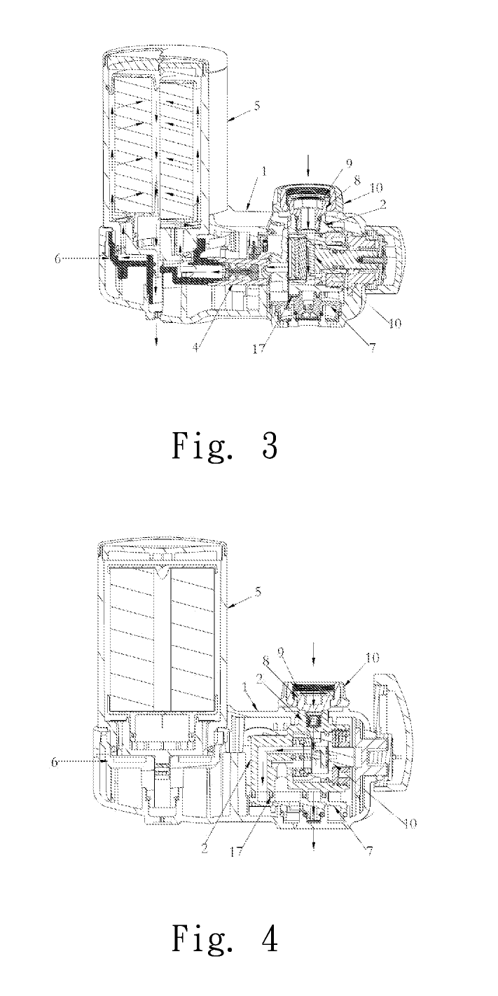

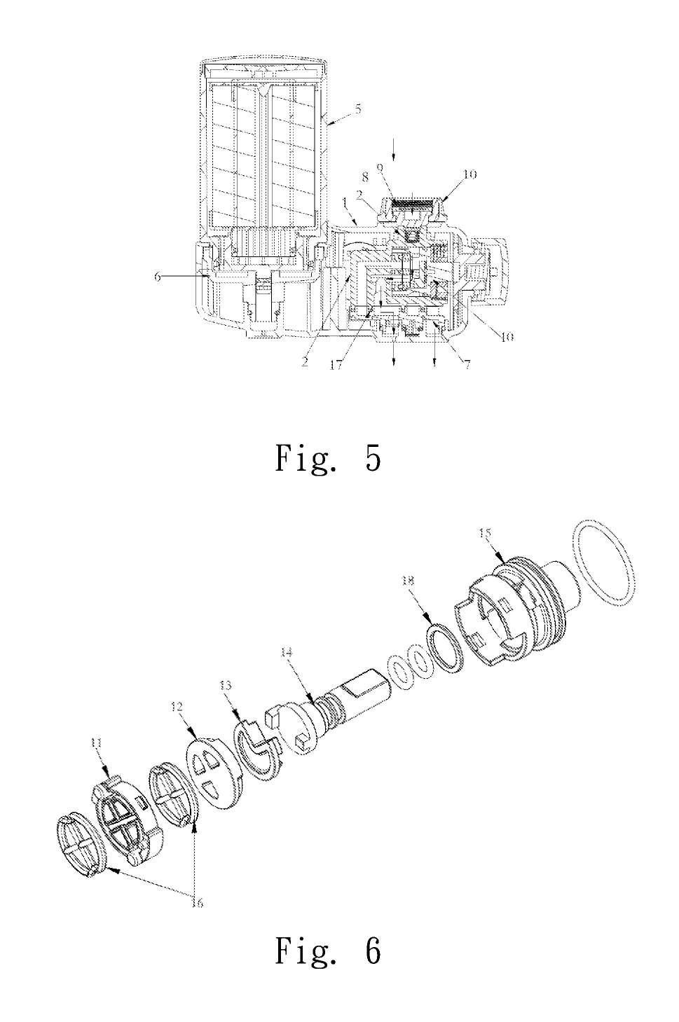

Refer to FIGS. 1 to 7 respectively for a perspective view of a faucet water filtering device according to an embodiment of the present invention; an exploded view of a faucet water filtering device as shown in FIG. 1 according to an embodiment of the present invention; a cross section view of a faucet water filtering device while outputting pure water according to an embodiment of the present invention; a cross section view of a faucet water filtering device while outputting raw water according to an embodiment of the present invention; a cross section view of a faucet water filtering device while outputting shower water according to an embodiment of the present invention; an exploded view of a ceramic valve core component according to an embodiment of the present invention; and a schematic diagram of water route in a ceramic valve core component according to an embodiment of the present invention.

As shown in FIGS. 1 to 7, the present invention provides a faucet water filtering device, including: a shell 1, a valve seat 2, a ceramic valve core component 3, a flow meter connection rod 4, a filter core 5, a filter core connection seat 6, and a connection seat 7. Wherein, the shell 1 is provided with a water input port on its top portion. The valve seat 2 is disposed in the shell 1, and is provided with a working valve having one input and three outputs, while an upper end of the valve seat 2 is connected to the water input port. The ceramic valve core component 3 is disposed in the valve seat 2. The flow meter connection rod 4 is inserted into a side of the shell 1, while the filter core 5 is disposed on a side of the shell 1. The filter core connection seat 6 is disposed on a side of the shell 1 for receiving the filter core 5, and is connected to a first water output port of the valve seat 2 through the flow meter connection rod 4 by means of a water route. And the connection seat 7 is disposed on bottom of the valve seat 2, and is provided with raw water and shower water hole channels corresponding to water output ports at bottom of the shell 1, and is connected to a second water output port and a third water output port of the valve seat 2 by means of the water routes.

The faucet water filtering device further includes: a water input connector 8, a water input filter plate 9, and an input water faucet screw tight nut 10, on a water input port of the valve seat 2.

At bottom of the filter core connection seat 6 is provided with a raw water output port connected and in communication with a filter core water output port.

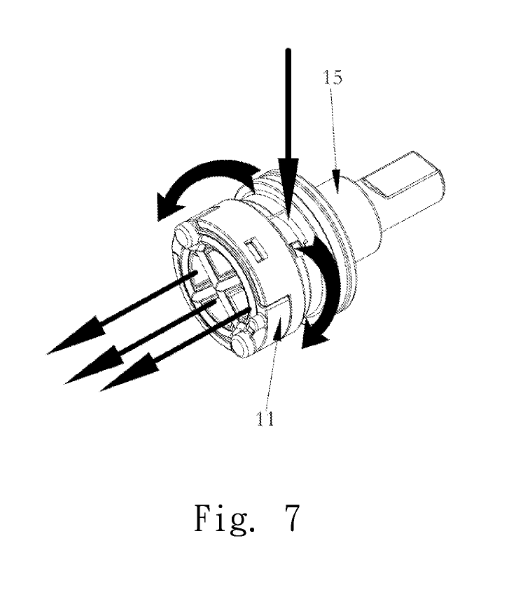

The ceramic valve core component 3 includes following elements disposed in sequence: a valve core support rack 11, a fix ceramic plate 12, a movable ceramic plate 13, a valve core rotation axis 14, a friction plate 18, and a valve core outer shell 15. As such, when water flows in from the water input end, it will flow through the holes on the outer shell of the valve core, and then into the ceramic plate, in achieving water routes switching as shown in FIG. 7.

The faucet water filtering device further comprises a valve core tight seal pad 16, disposed each on both sides of the valve core support rack 11.

The faucet water filtering device further comprises a tight seal pad 17 disposed between the connection seat 7 and the valve seat 2.

The operation principles of the present invention can be summarized as follows: through controlling the working valve having one input and three outputs, the objective of outputting pure water, raw water, and shower water can be achieved. In addition, the amount of water flowing into the filter core can be controlled through a flow meter installed on a flow meter connection rod, to control amount of pure water output from the filter core. For this purpose, a control valve of a flow meter has to be installed, to work in cooperation with a push button on the control console of the shell.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A faucet water filtering device, comprising:
a shell, provided with a water input port on a top portion thereof;
a valve seat, disposed in the shell, and provided with a working valve having one input and three outputs, while an upper end of the valve seat is connected to the water input port;
a ceramic valve core component, disposed in the valve seat;
a flow meter connection rod, inserted into a side of the shell;
a filter core, disposed on a side of the shell;
a filter core connection seat, disposed on a side of the shell for receiving the filter core, and connected to a first water output port of the valve seat through the flow meter connection rod by means of a water route; and
a connection seat, disposed on bottom of the valve seat, and provided with raw water and shower water hole channels corresponding to water output ports at bottom of the shell, and connected to a second water output port and a third water output port of the valve seat by means of the water routes.

2. The faucet water filtering device as claimed in claim 1, further comprising:
a water input connector, a water input filter plate, and an input water faucet screw tight nut, on a water input port of the valve seat.

3. The faucet water filtering device as claimed in claim 1, wherein at bottom of the filter core connection seat is provided with a pure water output port connected and in communication with a filter core water output port.

4. The faucet water filtering device as claimed in claim 1, wherein the ceramic valve core component includes following elements disposed in sequence: a valve core support rack, a fix ceramic plate, a movable ceramic plate, a valve core rotation axis, a friction plate, and a valve core outer shell.

5. The faucet water filtering device as claimed in claim 4, further comprising:
a valve core tight seal pad, disposed each on both sides of the valve core support rack.

6. The faucet water filtering device as claimed in claim 1, further comprising:
a tight seal pad disposed between the connection seat and the valve seat.
